(19) United States
(12) Patent Application Publication
(10) Pub. No.: US 2003/0140232 A1
(43) Pub. Date: Jul. 24, 2003

(54) Method and apparatus for secure encryption of data

(76) Inventor: Pierre De Lanauze, (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/053,139

(22) Filed: Jan. 21, 2002

(51) Int. Cl. G09C 3/00

(52) U.S. Cl. 713/186; 380/277

(57) ABSTRACT

A method for generating a cryptographic key from an analog signal representative of an image of a biometric feature of a user involves deriving binary output from the analog signal, and applying a selection algorithm to extract values from the binary output and arrange the values to form an identity bit string (IBS) of the user. The IBS may be modified by a transformation algorithm to generate a cryptographic key for decrypting messages sent to the user. The IBS may also be used to authenticate the user before a message can be decrypted.

### CROSS-REFERENCE TO RELATED APPLICATIONS

This is the first application filed for the present invention.

### MICROFICHE APPENDIX

Not applicable.

### TECHNICAL FIELD

The invention relates to the field of cryptography, and, in particular, to a cryptographic system that uses a key derived from an image of a biometric feature.

### BACKGROUND OF THE INVENTION

Encryption schemes have been used for thousands of years to protect secrets. In recent years information is increasingly being encrypted by computers and exchanged over public data networks. Messages sent over public data networks are vulnerable to being inspected by individuals who seek illicit access to encrypted material. Constant improvement to computer systems and developments in software have led to a race between system makers and system crackers to use the technology more efficiently. Many advances in encryption methods and systems have ensued.

Throughout the changes, encryption algorithms have largely relied on applying simple operations to successive bits, or blocks of bits, in encoded messages. Such simple operations include applying ‘exclusive or’ to respective bits of a pseudo-random number and the encoded message, or permuting the bits in blocks of a predefined size. Pseudo-random number generators are long cycles of Boolean values, that may be quickly and reliably generated by a group of linear feedback shift registers (LFSRs). An algorithm may involve any number of systematic manipulations to the encoded message, but the systematicity of algorithms make them vulnerable to being reversed by systematic attempt or best guess algorithms. As today's networked systems of computers can be co-opted to perform hundreds of computing years in days, or hours, the risk of using algorithm-based encryption techniques, is a growing and valid concern.

The security risks to purely algorithm-based encryption techniques are well known and one resolution involves generating keys or parts of encryption algorithms from analog signals. For example, in U.S. Pat. No. 6,253,223, which issued to Sprunk on Jun. 26, 2001, a random analog signal is used to generate a random digital bit string, which can be used to encrypt data. If there is nothing systematic about the generation of the bit string, it is generally not possible to decode the message without the bit string. Unfortunately, true random numbers are difficult to generate, they have to be securely disseminated, and must be retrievably stored. Random number sequences that are stored are difficult to retain as a secret, and those that are stored at different places are more difficult to secure.

This storage problem is addressed in the teachings of U.S. Pat. No. 6,233,339, which issued to Kawano et al. on May 15, 2001, wherein encryption information is not stored in a memory, but is a property of a physical system. Access to the physical system is guarded and a measurement of the physical system is performed whenever decryption or encryption is required. Unfortunately, the cryptographic system cannot be used to exchange messages, as the encryption and decryption information can only be derived from the physical system, unless appropriate keys are disseminated.

It is recognized in the art that a close association between users and their respective keys is highly desirable. U.S. Pat. No. 6,052,468, entitled METHOD OF SECURING A CRYPTOGRAPHIC KEY, which issued to Hillhouse on Apr. 18, 2000, discloses a method that permits the conditional release of a secured cryptographic key when biometric data authenticates a user. While meritorious, this method does not associate the user closely enough with the key. Hillhouse teaches encrypting a cryptographic key that is decrypted with a second key that is accessed using the biometric data. Cracking the cryptographic system therefore requires only obtaining one of: the cryptographic key, the second key, and the stored location of the second key. Preventing access to the second key without authentication requires more complicated security measures to keep safe.

Similarly, U.S. Pat. No. 5,995,630, entitled BIOMETRIC INPUT WITH ENCRYPTION, which issued to Borza on Nov. 30, 1999, discloses a method and system for providing data in dependence upon fingerprint information. According to Borza's invention, encryption and decryption keys are provided subsequent to a positive match between biometric input and a stored reference. According to the teachings of Borza, the release of a cryptographic key is also conditional upon successful authentication. Obtaining the key from other means is therefore possible. But according to Borza the image of the fingerprint is also used to encrypt the message. This is a meritorious invention. However, it imposes an inconvenient lower bound on the size of encrypted messages that is independent of the length of the messages.

What is therefore required is a secure cryptographic method including a secure method for generating a cryptographic key that is closely related to a person, and an apparatus for encrypting and decrypting messages.

### SUMMARY OF THE INVENTION

It is therefore an object of the present invention to provide a method for generating a cryptographic key from an analog signal representative of an image of a biometric feature of a user.

Another object is to provide an apparatus for encrypting and decrypting messages using the cryptographic key.

Accordingly, a method for generating a cryptographic key is provided. The method involves generating an analog signal representative of an image of a biometric feature of a user using a sensor. The analog signal is filtered to remove gray scale. A bit string is extracted from the filtered analog signal, and an IBS (IBS) is generated by selecting predetermined bits from the bit sting using a selection algorithm. The IBS may be used as a cryptographic key, or the method further comprises a step of generating the cryptographic key by applying a transformation algorithm to the IBS. The selection algorithm is preferably a secret algorithm for selecting bits from the bit string, and arranging and applying operations to the selected bits to form the IBS. The bit string generated from the analog signal is not derivable from information used to classify and identify images of the biometric feature, so that the IBS is, not derivable from information used to classify the biometric feature. Applying standard techniques for identifying and classifying the users' fingerprints can therefore not associate respective users and their respective IBSs. The method further comprises a step of issuing the IBS to a processor where the IBS is either used as a cryptographic key, or transformed into the cryptographic key using the transformation algorithm. The method may further comprise a step of using the IBS to authenticate the user, prior to applying the transformation algorithm or decrypting a message addressed to the user.

The processor preferably resides on a smart card, and the method then further comprises an initial step of inserting a smart card into a card reader that is operably connected with a sensor system and a communications processor from which the message is received. The step of using the IBS to authenticate then comprises a step of matching the IBS with a reference bit string associated with the user, that is stored on the smart card. The IBS is preferably adapted to execute the decryption of the message, by applying a decryption algorithm to the message using the cryptographic key. The decryption algorithm is preferably stored in a memory on the smart card.

According another aspect of the invention, an apparatus for decrypting a message includes a processor. adapted to receive an IBS derived from an analog signal representative of an image of a biometric feature of a user. The processor uses the IBS, in conjunction with a decryption algorithm, to decrypt a message. The processor may also be adapted to match the IBS with a reference bit string prior to decrypting the message, in order to authenticate the user. The processor may further be adapted to apply a transformation algorithm to the IBS in order generate a cryptographic key, used with the decryption algorithm to decrypt the message. If the processor resides on a smart card, the smart card preferably stores the transformation algorithm, the reference bit string, and the decryption algorithm, and is adapted to interface with a card reader that is adapted to receive the message and the IBS.

In accordance with a further aspect of the invention, an apparatus for decrypting a message includes a sensor system. The sensor system is adapted to extract a bit string from an analog signal representative of an image of a biometric feature of a user to whom the message is addressed. The bit string is used to generate the cryptographic key used to decrypt the message. The sensor system is composed of a sensor area and a charge coupled device (CCD) operably arranged with the sensor area to receive electromagnetic radiation from the biometric feature of the user for an interval of time of predetermined duration, when the biometric feature is adjacent to the sensor area. The CCD generates the analog signal representative of the image of the biometric feature. The sensor system further comprises an integrated circuit, connected with the CCD and adapted to receive the analog signal. The integrated circuit includes a filter adapted to remove gray scale from the analog signal, and a converter adapted to receive the filtered analog signal, and generate a binary output signal. The ASIC further includes a bit string extractor adapted to extract a bit string from the binary output. The integrated circuit is further adapted to apply the selection algorithm to generate the IBS from the bit string, and to send the IBS to the processor.

In accordance with another aspect of the invention, the system can enable a user to encrypt messages as well. A method for encrypting messages is therefore also provided. The user is first authenticated, which may involve the presentation of a biometric feature to a sensor area of a sensor, which is used to generate the IBS of the user. The IBS is matched with the reference bit string to authenticate the user, and, if the user is authenticated, an encryption key of a user to whom the message is addressed is accessed. The encryption key is used with the encryption algorithm to encrypt the message.

If a processor that performs the encryption, resides on a smart card, the method further comprises a step of inserting the smart card into a card reader that is adapted to receive the message and the IBS. The smart card stores the user's reference bit string, the encryption algorithm, and the addressed user's encryption key. The smart card also stores the decryption algorithm and the transformation algorithm (if there is one), if the smart card is issued to a user who is authorized to receive and decrypt messages.

### BRIEF DESCRIPTION OF THE DRAWINGS

Further features and advantages of the present invention will become apparent from the following detailed description, taken in combination with the appended drawings, in which:

FIG. 1 is a flow chart illustrating principal steps of a method in accordance with the invention for generating a cryptographic key;

FIG. 2 is a schematic block diagram of a smart card for secure encryption of data in accordance with the invention;

FIG. 3 is a schematic block diagram of a system in accordance with the invention;

FIG. 4a is a flow chart illustrating principal steps involved in issuing a smart card for decryption and encryption, in accordance with preferred embodiments of the invention;

FIG. 4b is a flow chart illustrating principal steps involved in issuing a smart card for decryption, in accordance with preferred embodiments of the invention;

FIG. 5 is a flow chart illustrating principal steps involved in encrypting a message, in accordance with the invention;

FIG. 6a is a flow chart illustrating principal steps involved in decrypting a message, in accordance with the present invention;

FIG. 6b is a flow chart illustrating principal steps involved in decrypting a message, in accordance with another embodiment of the present invention;

FIG. 7a is a schematic block diagram of a portable communications device on which a system in accordance with the invention is installed; and

FIG. 7b is a schematic block diagram of a portable computing device on which a system in accordance with the invention is installed.

It should be noted that throughout the appended drawings, like features are identified by like reference numerals.

### DETAILED DESCRIPTION OF THE PREFERRED EMBODIMENT

The invention enables secure encryption of data for a user. The system does not require the user to memorize a cryptographic key, or a complicated set of procedures to access a cryptographic key, as it does not involve the retrieval of the cryptographic key from storage. A biometric feature of the user is presented to a sensor system and a processor generates the cryptographic key on demand. The cryptographic key is generated from analog filtered output from the sensor system. The filtered output is converted to a binary signal, and a secret algorithm is used to select the cryptographic key from the binary signal. The cryptographic key cannot be used to identify the user nor can the biometric feature of the user be used to generate the cryptographic key without the secret algorithm.

Any human biometric feature can be used to implement the present invention. Fingerprints, face prints, and retinal scans are most commonly used today. Any of these features may be captured as images using a charge coupled device (CCD) that generates an analog signal.

A biometric feature is a characteristic pattern that is located on a surface area of human bodies, and is believed to uniquely identify any person. A biometric feature is complex enough to readily distinguish each of billions of people, and remains invariant for substantially the lifetime of the person. Although the fingerprint is one preferred biometric feature, because it is readily imaged or scanned, and because it has been used for a long time, any biometric feature of a person can be used to generate a bit string using methods in accordance with the invention. The bit string can then be used to generate a cryptographic key.

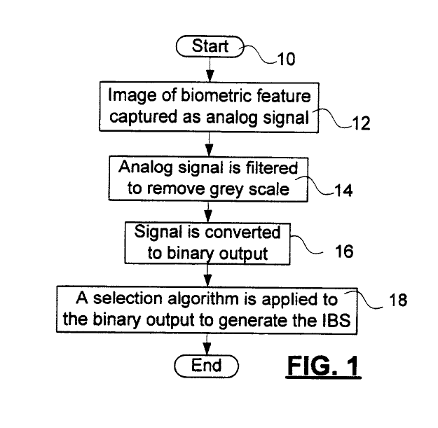

FIG. 1 illustrates principal steps involved in a method of generating an Identity Bit String (IBS) that either serves as, or is used to generate, the cryptographic key. The biometric feature in this example is a fingerprint. In step 10, a sensor detects an indication of a living finger on, or approaching, a sensor area. A high definition image of the finger is captured at a CCD that outputs an analog signal (step 12). The analog signal is filtered to remove gray scale (step 14) at an analog filter in an integrated circuit, such as an application specific integrated circuit (ASIC), connected to the CCD. In step 16, the filtered analog signal is converted to binary output, and a bit string is extracted from the binary output. A selection algorithm is applied to the bit string to generate an IBS, in step 18. The selection algorithm must reliably generate the same IBS from any image of a given finger that is captured by the sensor.

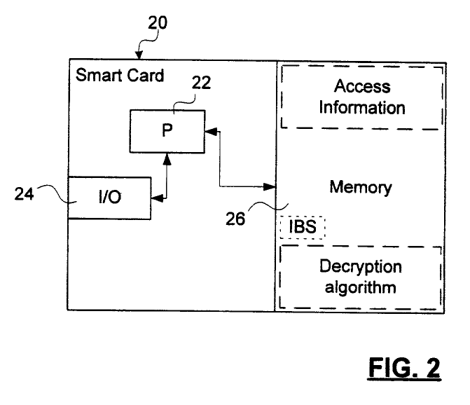

FIG. 2 schematically illustrates a smart card 20 for use in the system in accordance with the present invention. The smart card 20 is any portable device that comprises a memory 26 for storing at least the IBS, which is used as a reference bit string, and at least an essential part of a decryption algorithm. Preferably, the smart card 20 includes a processor 22 that is adapted to execute the decryption algorithm using the cryptographic key, so that secrecy of the decryption algorithm can be more readily ensured. If, on the other hand, the decryption algorithm (or an essential component thereof) is stored on the smart card 20 and downloaded to an external processor prior to decryption, the decryption algorithm may be retained by the computer and inspected. The smart card 20 may also be adapted to generate the cryptographic key from the IBS by applying a transformation algorithm to the IBS, if the IBS matches a reference bit string stored on the card.

The smart card 20 is used as the memory storage device because smart cards can be made nearly invulnerable to reverse engineering or unauthorized access. Smart cards are compact, they readily interface with other systems, and they may store adequate amounts of data to be used in accordance with the present invention. Moreover, certain smart cards comprise processors enabling them to perform algorithms, such as the transformation, decryption and encryption algorithms of the present invention.

As schematically illustrated in FIG. 2 the processor 22 is adapted to exchange data with an input/output (I/O) interface 24, and the memory 26. The memory 26 may be, for example, electrically erasable programmable read only memory (EEPROM). The memory 26 stores access information related to the user to whom the smart card 20 is issued, and at least an essential part of the decryption algorithm. In certain embodiments, the card also stores an encryption algorithm and encryption keys, each associated with a respective other user. Hidden in the memory 26 is the user's IBS, called a reference bit string. Each user preferably uses the same decryption algorithm, but a different cryptographic key. The cryptographic key may be derived from the IBS by the application of a transformation algorithm, which is also preferably stored on the smart card 20.

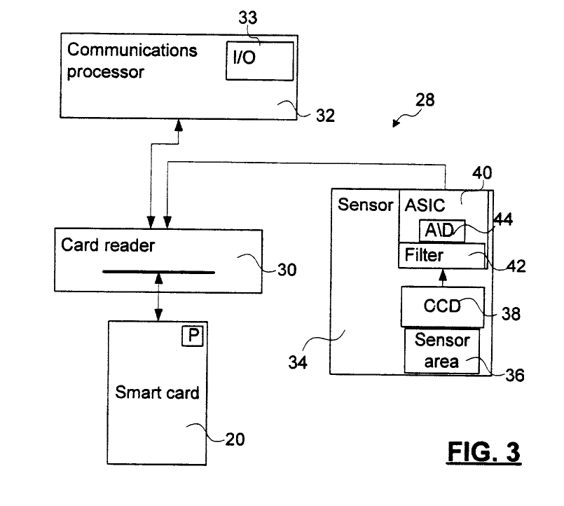

FIG. 3 schematically illustrates a system 28 in accordance with the invention. The smart card 20 is adapted to interface with the system 28 via a card reader 30. The smart card 20 and card reader 30 may use contact, contactless, or both contact and contactless modes, which are known in the art. The card reader 30 is also interconnected to a communications processor 32, and a sensor system 34.

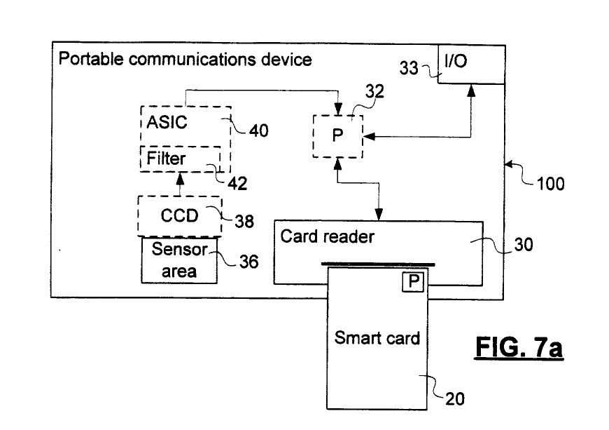

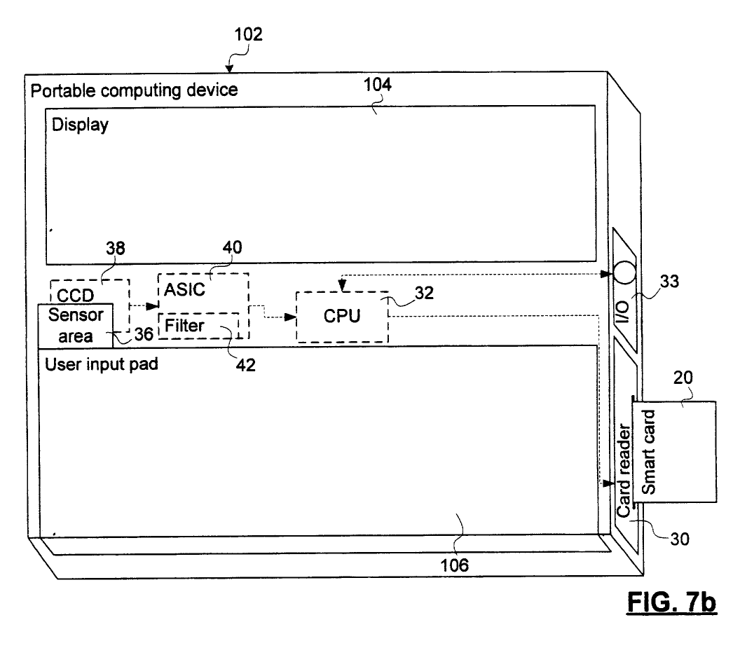

The communications processor 32 may reside in a computer that interfaces with a data network, or it may be a wireless communications device, a personal digital assistant, wireless application protocol (WAP) phone, web browser, etc. It is adapted to exchange encrypted messages with a data network and with the card reader, and is therefore connected to an input/output port 33. Possible instantiations of the system will be described in more detail below with reference to FIGS. 7a,b.

The sensor system 34 comprises a sensor area 36, a charge coupled device (CCD) 38, and an application specific integrated circuit 40. The sensor area 36 is preferably configured to facilitate image capture of the biometric feature. For example, if the biometric feature is a fingerprint, the sensor area 36 is arranged to guide a user's finger into a predetermined position over the sensor area 36. There are preferably other sensors associated with the sensor area 36 that are used to measure vital signs, or other indicators of the state of the user's finger, to prevent authentication upon presentation of a sculptured replica of a finger, a dismembered finger, or the like. The CCD 38 is positioned with respect to the sensor area 36 to receive electromagnetic radiation reflected by, or radiated from, the biometric feature. The CCD 36 generates an analog signal during an exposure interval of predefined duration. The analog signal is then transferred to the ASIC 40. The ASIC 40 includes one or more analog filters 42 adapted to remove gray scale from the analog signal to sharpen the contrast of the captured image. The filtered analog signal is then converted into binary output by a converter 44.

Preferably the binary output is of a predetermined length. The ASIC 40 is adapted to apply a selection algorithm to the binary output in order to generate the IBS, which is shorter than the length of the binary output. The selection algorithm is secret, so that deriving the IBS of a user from an image of the biometric feature is only possible using a sensor system 34 in accordance with the invention. The selection algorithm is designed so values selected from the binary output and arranged to form the IBS are not derivable from features and measurements used to classify and identify the biometric feature. This can be achieved by selecting values without using geometrical representations in accordance with standard classification and identification techniques. Rather, in preferred embodiments of the invention, the IBS is not a set of geometrical relations, but binary values extracted from binary output generated using the analog filtered image of the biometric feature of the user.

The IBS is generated at the sensor system 34, and conveyed to the smart card 20 via the card reader 30. The smart card 20 authenticates the user by comparing the IBS with a reference bit string (IBS) associated with the user, and then uses the IBS, or a cryptographic key derived from it, to decrypt a message sent to the user. In accordance with certain embodiments, the authenticated user can also encrypt a message to be sent to another user, by accessing an encryption key associated with the other user. This requires that more information be stored on the smart card, especially if the encryption and decryption algorithms are different.

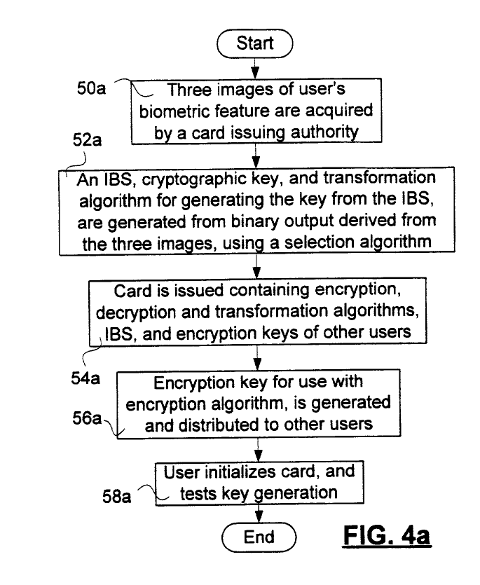

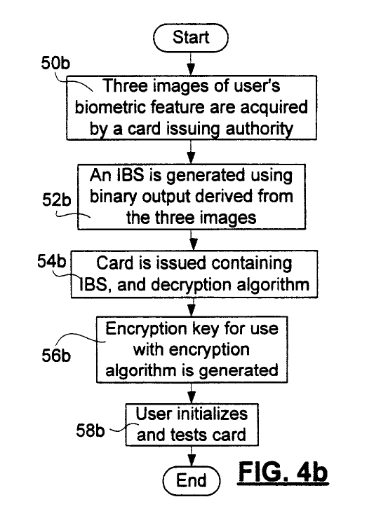

FIG. 4a is a flow chart illustrating principal steps involved in issuing the smart card 20 in accordance with a first embodiment. In step 50a, three images of the user's biometric feature are captured, each generating an analog signal. The analog signal is filtered, and converted into binary output. The selection algorithm is applied to the binary output yielding the IBS (step 52a). Also in step 52a, a transformation algorithm is optionally applied to the IBS to generate the cryptographic key. As described above, the IBS may in itself be used as the cryptographic key. The transformation algorithm may be used to generate respective cryptographic keys from respective IBSs of any user. Alternatively, the transformation algorithm may be a set of operations unique to each user defined in step 52a, and maintained as a secret.

In step 54a the smart card 20 is issued to the user, who is then equipped to receive encrypted messages and to decrypt them. The smart card 20 stores a copy of the IBS of the user (the reference bit string), the decryption algorithm, optionally an encryption algorithm, the transformation algorithm, and cryptographic keys of all of the users to whom the user is entitled to send encrypted messages. In step 56a, the cryptographic key, decryption algorithm, and encryption algorithm are used to generate an encryption key that, in conjunction with the encryption algorithm, serves to encrypt messages to be decrypted by the decryption algorithm, in conjunction with the cryptographic key. The encryption key is copied to the smart cards of other users who wish to send encrypted messages to the user, also in step 56a. The smart cards 20 may store new encryption keys after initialization, or the other users may store the encryption keys on respective memories associated with communications processors, for example. The smart card 20 is initialized and tested (step 58a), and the procedure is complete.

FIG. 4b is a flow chart illustrating principal steps involved in the issuing of the smart card 20 in accordance with a second embodiment. The method of FIG. 4b differs from that of FIG. 4a in two respects. First, the user's cryptographic key is identical with the user's IBS, so the transformation algorithm is neutral. For this reason, in step 52b only the IBS (which sensors the cryptographic key) is generated. Second, the smart card 20 of the second embodiment is optionally used only for encryption, and therefore stores neither the encryption algorithm, nor the encryption keys of other users. Steps 50b, 56b, and 58b are substantially identical to the corresponding steps described above with reference to FIG. 4a.

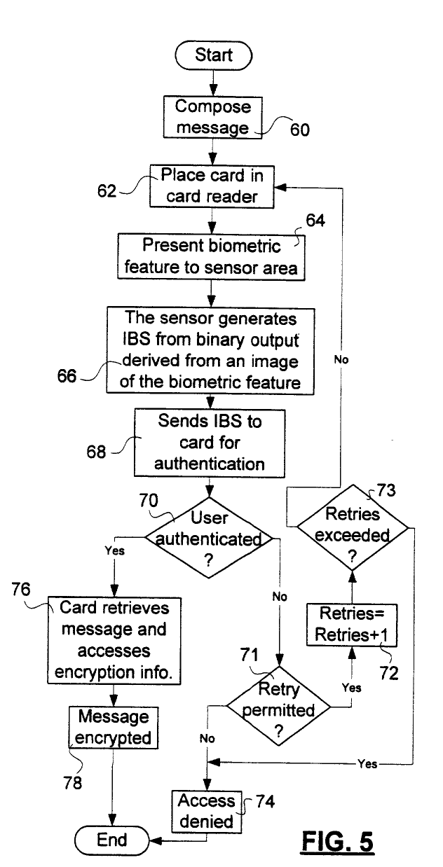

FIG. 5 illustrates the principal steps involved in encrypting a message using the smart card 20. In step 60, the sender composes the message to be sent to the user. The sender places his/her smart card 20 in the card reader 30 (step 62), and presents a predefined biometric feature to the sensor area 36 of the sensor system 34 (step 64). The sensor system 34 generates the sender's IBS (step 66), which is sent to the smart card 20 (step 68), via the card reader 30. The smart card 20 authenticates the sender by matching the IBS it receives with the stored reference bit string. If, in step 70, the sender is not authenticated, it is determined whether the user is permitted another try (step 72).

There are many possible responses to a failed attempt that may depend on the probability of failed authentication, a level of security associated with the message, etc. Second authentication procedures may be invoked, or other security precautions may be invoked if the authentication fails. The smart card 20 may be erased or retained by the card reader, if another attempt is denied, in step 72. Otherwise, the smart card is ejected and the procedure returns to step 62. If, on the other hand, in step 70, the user is authenticated, the smart card 20 requests the message from the communications processor 32, determines the addressee of the message, and accesses the encryption information uniquely associated with the addressee (step 76). In step 78, the smart card 20 uses the encryption information to encrypt the message, ending the procedure.

Accessing the encryption information in step 76 may involve different operations depending on the embodiment of the invention. For example, in the first embodiment, the users' encryption keys (including that of the addressee) are stored in the memory 26 of the smart card 20. Accessing the encryption information therefore involves obtaining the encryption key of the recipient and accessing the encryption algorithm, which is used for encrypting messages to be sent to the recipient. Alternatively, the encryption information may be accessed using the communications processor 32, a data network to which the communications processor 32 is connected, or any combination of the communications processor 32, the memory 26 of the smart card 20, and the data network. The encryption information may include more than just the encryption key, as well as at least an essential part of an encryption algorithm. The encryption algorithm may either be specific to the user, or used for encrypting messages to any number of users. The communications processor 32 may further execute the encryption algorithm and the smart card 20 may contain an essential component to the encryption algorithm, and thus be required for encryption, as well as for authentication.

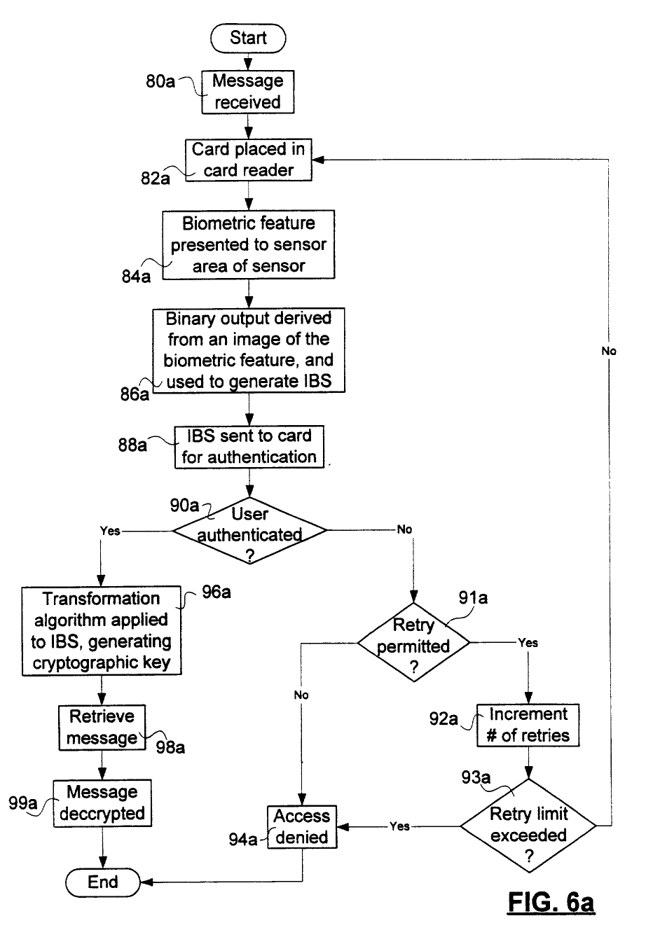

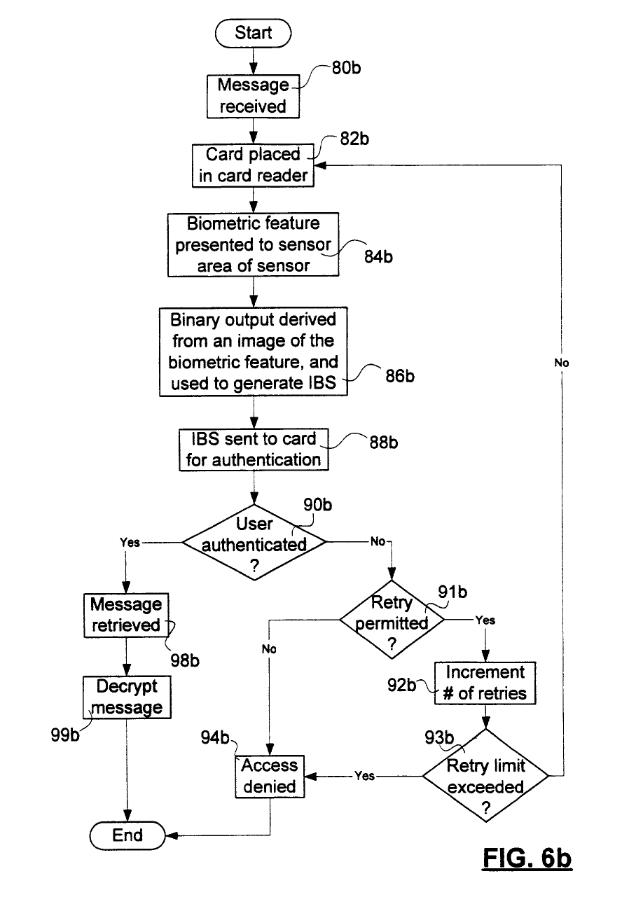

Principal steps involved in decrypting a message in accordance with the invention are illustrated in FIGS. 6a,b. FIG. 6a illustrates an embodiment in which a transformation algorithm is applied to the IBSs in order to generate a cryptographic key. The method of decrypting a message begins when a message is received at the communications processor 32 (step 80a). In order to decrypt the message, the addressed user inserts his/her smart card 20 to the card reader 30 (step 82a), and presents the biometric feature to the sensor area 36 of the sensor system 34 (step 84a). The sensor system 34 generates the IBS of the user (step 86a), and forwards the IBS to the smart card 20 (step 88a).

The smart card 20 receives the IBS, and matches the IBS with the reference bit string, in order to authenticate the user. If, in step 90a the user is not authenticated, it is determined whether the user may re-attempt access to the decryption algorithm (step 92a). If the user is not permitted to reattempt, access is denied (step 94a). If the user is permitted to re-attempt access, the procedure returns to step 82a. If, in step 90a, the user is authenticated, the decryption algorithm is accessed and the transformation algorithm is applied to the IBS, generating the cryptographic key (step 96a). The smart card 20 requests the message from the communications processor 32 (step 98a), and then decrypts the message using the cryptographic key and the decryption algorithm (step 99a).

The method illustrated in FIG. 6b is an alternate embodiment to that shown in FIG. 6a. Steps 80a-94a are identical to steps 80b-94b of FIG. 6b. In step 98b, the smart card 20 receives the message from the communications processor 32, as requested. The message is decrypted using the decryption algorithm and the IBS (step 99b), which serves as the cryptographic key.

FIGS. 7a,b illustrate two possible instantiations of systems in accordance with the invention. The system may reside on a portable communications device 100 or a portable computing device 102, for example.

A portable communications device 100 provides a convenient housing for the system in accordance with the invention. The portable communications device 100 includes the card reader 30 for interfacing with a smart card 20, and a communications processor 32 adapted to control the flow of encrypted messages, and to interface with a wireless network via the I/O port 33. The portable communications device 100 further comprises the sensor area 36, and CCD 38 operatively arranged to permit imaging the biometric feature. The output of the CCD 38 is an analog signal representative of an image of the biometric feature, which is sent to the ASIC 40. An analog filter 42 strips out gray scale, and the analog signal is converted into binary output. The IBS is extracted from the binary output using the selection algorithm. The IBS is derived from the binary output signal in a systematic manner so that the IBS is reliably generated from the image of the biometric feature of the user. The values taken from the bit string for generating the IBS cannot be derived from biometric information used for classifying and identifying biometric features. This adds to the unfeasibility of guessing or calculating the IBS of a user given an image of the biometric feature.

A portable computing device 102 is schematically illustrated in FIG. 7b. The portable computing device 102 includes a display 104, a user input pad 106, and a central processing unit (CPU), which serves as the communications processor 32 of the current instantiation of the invention. The CPU 32 is adapted to control the flow of encrypted messages to and from the card reader 30, and a data network (via I/O port 33). The card reader 30 is adapted to interface with the smart card 20. The portable computing device 102 also has the CCD 38 arranged to acquire images of biometric features presented to the sensor area 36. The CCD 38 generates analog signals that are output to the ASIC 40. The ASIC 40 filters out the gray scale (using at least one analog filter 42) and converts the filtered analog signal into binary output. The ASIC 40 also generates the IBS. The IBS is then sent to the card reader 30 via the CPU 32 for authentication, and decryption or encryption of a message.

The invention therefore provides a secure method of encrypting data using encryption keys that cannot be locked or otherwise compromised. Unlike digital encryption keys that can be determined given enough computing time, the encryption keys in accordance with the invention cannot be deduced or associated with a person to which they are related. The invention therefore provides a system that ensures privacy while providing optimal security.

The embodiments of the invention described above are intended to be exemplary only. The scope of the invention is therefore intended to be limited solely by the scope of the appended claims.

I/We claim:

1. A method for generating a cryptographic key, comprising steps of:
using a sensor to acquire an image of a biometric feature of a user;
generating binary output from analog signals output by the sensor; and
generating the cryptographic key from the binary output using a selection algorithm.

2. A method as claimed in claim 1 wherein the step of generating is performed using a secret algorithm for selecting, arranging, and performing operations on the binary output.

3. A method as claimed in claim 2 wherein the encryption key is a key for a private key cryptographic system.

4. A method as claimed in claim 3 wherein the step of extracting comprises steps of:
receiving the image in an analog signal format;
passing the analog signal through an analog filter to remove gray scale from the analog signal; and
converting the filtered analog signal to a binary output signal.

5. A method as claimed in claim 4 wherein the step of using a sensor comprises steps of:
receiving electromagnetic radiation from the biometric feature at a charge coupled device; and
acquiring an image of the biometric feature.

6. A method as claimed in claim 5 wherein the biometric feature is a pattern located on a predefined surface area of a body and the step of deriving further comprises an initial step of measuring a life sign indicator of the surface area of the body in order to verify that the image is of a living being.

7. A method as claimed in claim 4 wherein the cryptographic key is derived from values extracted from the binary output that are unrelated to information used to classify or identify the biometric feature, so that the information cannot be used to associate the cryptographic key with the biometric feature.

8. A method as claimed in claim 4 further comprising a step of forwarding an IBS to a processor that stores a decryption algorithm for use with the cryptographic key to decrypt messages addressed to the user.

9. A method as claimed in claim 8 wherein the processor has access to a decryption algorithm that uses the IBS as the cryptographic key, and the method further comprises a step of using the IBS to authenticate the user by determining if the IBS matches a reference bit string, prior to decrypting the message.

10. A method as claimed in claim 9 wherein the processor resides on a smart card, and the method further comprises an initial step of inserting the smart card into a card reader that is adapted to receive both the message and the IBS.

11. A method as claimed in claim 8 wherein the step of generating is performed by the processor, and comprises steps of:
receiving the IBS; and
applying a transformation algorithm to the IBS to generate the cryptographic key.

12. A method as claimed in claim 11 wherein the step of generating further comprises a step of using the IBS to authenticate the user by verifying that the IBS matches a reference bit string, prior to the step of applying.

13. A method as claimed in claim 12 wherein the processor resides on a smart card that stores a decryption algorithm that uses the cryptographic key, and the method further comprises an initial step of inserting the smart card into a card reader provisioned with a memory for receiving the IBS and the message.

14. An apparatus for decrypting an encrypted message addressed to a user, the apparatus comprising a processor adapted to use an IBS derived from an image of a biometric feature of the user in conjunction with a decryption algorithm to decrypt the encrypted message.

15. An apparatus as claimed in claim 14 wherein the processor is adapted to use the IBS as a cryptographic key to decrypt the message using the decryption algorithm.

16. An apparatus as claimed in claim 15 wherein the processor is further adapted to first authenticate the user by matching the IBS with a reference bit string prior to decrypting the message.

17. An apparatus as claimed in claim 14 wherein the processor is further adapted to:
use the IBS to authenticate the user, by matching the IBS with a reference bit string associated with the user;
if the user is authenticated, apply a transformation algorithm to the IBS in order to generate a cryptographic key; and
decrypt the message using the cryptographic key and a decryption algorithm.

18. An apparatus as claimed in claim 17 wherein the processor resides on a smart card that stores the transformation algorithm, the decryption algorithm, and the reference bit string.

19. An apparatus as claimed in claim 18 wherein the smart card is docked at a card reader adapted to interface with both a sensor system, from which the IBS is received, and a communications processor from which the message is received.

20. An apparatus for generating a cryptographic key comprising a sensor system adapted to:
capture an image of a biometric feature of a user; and
extract from the image an identity bit string (IBS) used to generate the cryptographic key.

21. An apparatus as claimed in claim 20 wherein the sensor system comprises an integrated circuit adapted to generate the cryptographic key by selecting, arranging, and performing operations on the IBS using a selection algorithm.

22. An apparatus as claimed in claim 21 wherein the cryptographic key is a key for a private key cryptographic system.

23. An apparatus as claimed in claim 21 wherein the sensor system further comprises a sensor for generating an analog signal representative of the image of the biometric feature, and wherein the integrated circuit further comprises:
an analog filter adapted to eliminate gray scale from the analog signal;
a converter adapted to convert the filtered analog signal to binary output; and
a selection algorithm adapted to extract the IBS from the binary output.

24. An apparatus as claimed in claim 23 wherein the sensor comprises a charge coupled device (CCD) adapted to generate the analog signal in response to electromagnetic radiation, and the biometric feature comprises a predefined surface area of a user's body.

25. An apparatus as claimed in claim 24 wherein the sensor is adapted to capture an image of a fingerprint, and the sensor area further comprises means for acquiring at least one measurement indicating that a finger placed on the sensor area is the finger of a living being.

26. A method as claimed in claim 23 wherein the cryptographic key is derived from values, and relations of values derived from the analog signal that are unrelated to information used to classify and identify the biometric feature, so that such information cannot be used to associate the cryptographic key with the biometric feature.

27. An apparatus as claimed in claim 23 wherein the integrated circuit comprises:
a circuit for generating an IBS by selecting, arranging, and performing operations on values obtained from the binary output using a predefined selection algorithm; and
a circuit for sending the IBS to a processor.

28. An apparatus as claimed in claim 27 wherein the processor is further adapted to generate the cryptographic key from the IBS by applying a transformation algorithm to the IBS.

29. An apparatus as claimed in claim 28 wherein the processor resides on a smart card, and the apparatus further comprises a card reader, the smart card being adapted to:
receive the IBS from the integrated circuit, via the card reader;
determine if the IBS matches a reference bit string associated with the user, to authenticate the user;
if the user is authenticated, to apply the transformation algorithm to the IBS to generate the cryptographic key; and
apply a decryption algorithm to the message using the cryptographic key.

30. A method for encrypting a message addressed to a user comprising a step of applying an encryption algorithm to the message using an encryption key derived from binary output generated from an analog signal associated with an image of a biometric feature of the user.

31. A method as claimed in claim 30 further comprising a step of:
authenticating the user by comparing the IBS with a reference bit string uniquely associated with the sender.

32. A method as claimed in claim 31, further comprising a step of inserting a smart card into a card reader, the card reader being adapted to convey the IBS to the smart card.
